(19) United States
(12) Patent Application Publication
(10) Pub. No.: US 2025/0371830 A1
(43) Pub. Date: Dec. 4, 2025

(54) DISPLAY METHOD AND DISPLAY DEVICE

(71) Applicant: Lenovo (Beijing) Limited, Beijing (CN)

(72) Inventors: Wei JING, Beijing (CN); Cen YAO, Beijing (CN); Nianlong LI, Beijing (CN)

(21) Appl. No.: 19/222,655

(22) Filed: May 29, 2025

(30) Foreign Application Priority Data
May 29, 2024 (CN) 202410684144.7

(51) Int. Cl. G06T 19/20; G06F 3/01; G06T 15/50

(52) U.S. Cl. CPC G06T 19/20; G06F 3/013; G06T 15/506; G06T 2200/24; G06T 2219/2016

(57) ABSTRACT

A display method includes obtaining an interactive operation and an operation parameter for a first object displayed in a naked-eye 3D state. The operation parameter characterizes the interactive operation. The method further includes displaying a second object in response to the operation parameter satisfying a target condition, obtaining position information related to the first object in response to the interactive operation, and controlling a display state of the second object based on the position information.

### CROSS-REFERENCE TO RELATED APPLICATION

This application claims priority to Chinese Patent Application No. 202410684144.7, filed on May 29, 2024, the entire content of which is incorporated herein by reference.

### TECHNICAL FIELD

The present disclosure generally relates to the field of 3D display technologies and, more particularly, to a display method and a display device.

### BACKGROUND

In a 3D interactive scene, users can interact with objects in the scene through their hands. Because of differences in the perception of 3D effects among different users, users may not be able to accurately perceive the spatial relationship between people and 3D objects when touching them, thus affecting the users' interactive experience in the 3D scene.

### SUMMARY

In accordance with the disclosure, there is provided a display method including obtaining an interactive operation and an operation parameter for a first object displayed in a naked-eye 3D state. The operation parameter characterizes the interactive operation. The method further includes displaying a second object in response to the operation parameter satisfying a target condition, obtaining position information related to the first object in response to the interactive operation, and controlling a display state of the second object based on the position information.

Also in accordance with the disclosure, there is provided an electronic apparatus including a memory storing a computer program and a processor configured to execute the computer program to obtain an interactive operation and an operation parameter for a first object displayed in a naked-eye 3D state. The operation parameter characterizes the interactive operation. The processor is further configured to execute the computer program to display a second object in response to the operation parameter satisfying a target condition, obtain position information related to the first object in response to the interactive operation, and control a display state of the second object based on the position information.

Also in accordance with the disclosure, there is provided a non-transitory computer-readable storage medium storing a computer program that, when executed by a processor, causes an electronic apparatus having the processor to obtain an interactive operation and an operation parameter for a first object displayed in a naked-eye 3D state. The operation parameter characterizes the interactive operation. The computer program, when executed by the processor, further causes the electronic apparatus to display a second object in response to the operation parameter satisfying a target condition, obtain position information related to the first object in response to the interactive operation, and control a display state of the second object based on the position information.

### BRIEF DESCRIPTION OF THE DRAWINGS

FIG. 1 is a flow chart of a display method consistent with embodiments of the present disclosure

FIG. 2 is a schematic diagram showing an application scenario of a display method consistent with embodiments of the present disclosure.

FIG. 3 is a schematic diagram showing another application scenario of a display method consistent with embodiments of the present disclosure.

FIG. 4 is a schematic diagram showing another application scenario of a display method consistent with embodiments of the present disclosure.

FIG. 5 is a schematic diagram showing controlling a display state consistent with embodiments of the present disclosure.

FIG. 6A is another schematic diagram showing controlling a display state consistent with embodiments of the present disclosure.

FIG. 6B is another schematic diagram showing controlling a display state consistent with embodiments of the present disclosure.

FIG. 7A is another schematic diagram showing controlling a display state consistent with embodiments of the present disclosure.

FIG. 7B is another schematic diagram showing controlling a display state consistent with embodiments of the present disclosure.

FIG. 8 is a schematic structural diagram of a display device consistent with embodiments of the present disclosure.

FIG. 9 is a schematic structural diagram of an electronic apparatus consistent with embodiments of the present disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

In the technical solution of the present disclosure, the collection, storage, use, processing, transmission, provision, disclosure and application of the data involved (such as but not limited to user personal information) comply with the provisions of relevant laws and regulations, necessary confidentiality measures are taken, and they do not violate public order and good morals.

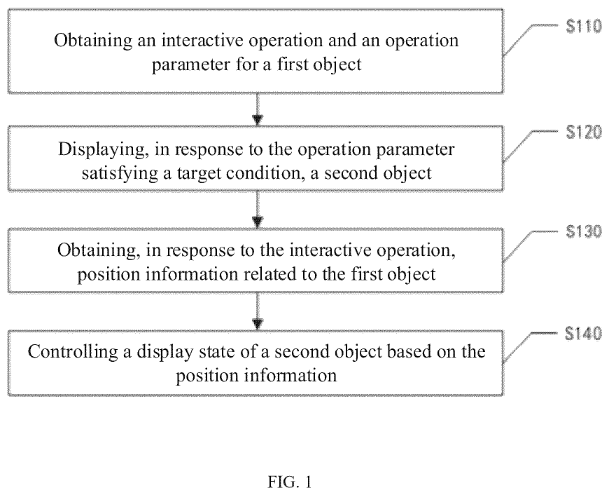

The present disclosure provides a display method. In one embodiment, as shown in FIG. 1, which is a flow chart of a display method consistent with the present embodiment, the display method includes S110 to S140.

At S110, an interactive operation and an operation parameter for a first object are obtained, where the operation parameter characterizes the interactive operation and the first object is displayed in a naked-eye 3D state.

In one embodiment of the present disclosure, the first object may be an object that a user wants to interact with in a 3D scene. For example, the first object may be displayed in a naked-eye 3D state in the 3D interactive scene, and the user may directly perceive the first object presented in a 3D effect through the naked eye without the aid of auxiliary tools such as polarized glasses. The user may determine the position of the first object through perception and perform the interactive operation with the first object. The interactive operation may be an operation performed by the user related to the first object. For example, the interactive operation may be an action of the user touching the first object, or may be a complete set of coherent actions in which the user raises his hand, moves his hand near the first object, and then interacts with the first object.

The operation parameter may be a parameter used to characterize the interactive operation, and the operation content of the interactive operation may be determined based on the operation parameter. For example, the operation parameter may describe the distance relationship between the user's hand and the first object during the user's hand performing the interactive operation. As another example, the operation parameter may describe whether the user's sight line is focused on the 3D scene. For yet another example, the operation parameter may describe the user's movement trajectory when the user performs the interactive operation by hand. The present disclosure has no limit on this.

In one embodiment, the interactive operation may be captured based on an image acquisition device. For example, the process of the user performing the interactive operation may be captured by a camera or an infrared device, and the interactive operation and operation information may be determined based on the captured data. For example, the captured data may be an image with depth information. It should be noted that the capture of the user's interactive operation is performed with the user's permission.

At S120, in response to the operation parameter satisfying a target condition, a second object is displayed.

In one embodiment of the present disclosure, the target condition may be related to a parameter characterizing the user's intention to interact with the first object. For example, the operation parameter satisfying the target condition may include that the interactive operation characterized by the operation parameter is able to reflect that the user wants to interact with the first object. The second object may be a prompt object that appears in the 3D scene to assist the user in interacting with the first object. For example, through the second object, the user may be able to accurately perceive the position of the first object. For example, the second object may be displayed in a naked eye 3D state or in a 2D state.

The position information of the first object in the 3D scene may include depth information. Because of certain differences in the perception of the depth information by different users, the perception results of the position of the first object in the 3D scene by different users may be inconsistent, or the position perceived by the user may be inconsistent with the actual position of the first object. This difference in perception may cause the user to have an interaction illusion during the interaction process. For example, the user may subjectively believe that he has interacted with the first object, but in fact the interaction has not been successful.

By displaying the second object in the same scene as the first object, the second object may be used to help the user perceive the depth information of the first object and determine the specific situation of the interaction with the first object. For example, the second object may be a virtual hand formed by the user's hand projected in the 3D scene, or the second object may be an indicator cursor formed by the user's sight line in the 3D scene, or the second object may represent the corresponding texture pattern formed on the first object based on different positions of the user's hand.

For example, the operation parameter satisfying the target condition may include that the distance between the user's hand and the first object to be interacted is within a preset threshold, and the display state of the second object in the scene may help the user perceive the positional relationship between the first object and the user.

As another example, the operation parameter satisfying the target condition may include that the amplitude of the interactive operation performed by the user's hand is not less than a preset amplitude, and the display state of the second object in the scene may help the user perceive the relationship with the first object.

At S130, in response to the interactive operation, the position information related to the first object is obtained.

In one embodiment of the present disclosure, the position information related to the first object may be used to represent the relative position information between the user's hand performing the interactive operation and the first object, or may represent the relative position information between the first object and the displayed second object.

For example, the interactive operation may be that the user moves his hand near the first object. Correspondingly, the position information related to the first object may be expressed as the position and distance of the user's hand relative to the first object, or the position and distance of the second object displayed in the 3D scene relative to the first object.

At S140, the display state of the second object is controlled based on the position information.

In one embodiment of the present disclosure, the display state of the second object may be controlled to change accordingly based on the change of the position information. The user may perceive the positional relationship between the second object and the first object through the change of the display state of the second object, to determine the depth information of the first object.

For example, when the position information indicates that the user does not touched the first object, the display state of the second object may remind the user to adjust the position of the hand. When the user touches the first object, the display state of the second object may enable the user to determine that the interaction with the first object is successful.

In one embodiment of the present disclosure, the display state of the second object may be related to the user's interactive operation. When the user performs the interactive operation by hand, the image acquisition device may capture the position information and posture information of the user's hand during the interactive operation, and the processor may display the second object based on the position information and posture information. When the position information and posture information change, the processor may change the display state of the second object accordingly. Based on the change in the display state of the second object, the user may accurately perceive the positional relationship between the hand and the first object when performing the interactive operation, eliminating the perception error. When the user cannot accurately perceive the change in the position information, the processor may present the change in the position information as a change in the display state of the second object, to present the change in the position information to the user through a visual effect, and help the user perceive the first object.

In the embodiments of the present disclosure, the user may interact with the first object, and the display state of the second object may serve as a prompt to assist the user in interacting with the first object. When the user's perception of the first object to be interacted with deviates, the second object may also serve as a guide to help the user perceive the first object. During the movement of the user's hand, the change in the relative position caused by the movement may control the display state of the second object, such that the user may perceive the first object to be interacted with more accurately and perform interactive operations by observing the display state of the second object, which may effectively optimize the user's interactive experience while improving the interaction efficiency.

In some embodiments of the present disclosure, in response to the interactive operation, obtaining the position information related to the first object may include: determining a plurality of sub-operations included and executed in sequence in the interactive operation; and obtaining the position information related to the first object in response to target sub-operations in the plurality of sub-operations.

The interactive operation may be a relatively directional action such as the user moving a hand near the first object, or may be a plurality of coherent actions generated when the user intends to interact with the first object and invalid operations unrelated to the interactive operation. The plurality of sub-operations may be multiple single operations after decomposing the plurality of coherent actions generated by the user.

For example, after the image acquisition device obtains the interactive operation, the processor may analyze and split the interactive operation, to decompose the user's interactive operation into the plurality of sub-operations: sub-operation A, sub-operation B, sub-operation C, and sub-operation D. The processor may analyze the plurality of sub-operations one by one and determine the target sub-operations from the plurality of sub-operations. The processor may control the display state of the second object based on the information represented by the target sub-operations.

For example, when the action amplitude of sub-operation A is small and the distance from the first object is far, it may be considered that sub-operation A is an accidental touch operation performed by the user. When sub-operation C is a continuity action connecting sub-operation B and sub-operation D, the processor may determine that sub-operation A and sub-operation C are invalid actions, and sub-operation A and sub-operation C do not affect the display state of the second object. The processor may take sub-operation B and sub-operation D as target sub-operations, and obtain the position information related to the first object during the execution of sub-operation B and sub-operation D and control the display state of the second object.

As another example, after determining a first target sub-operation, the processor may take all subsequent sub-operations as target sub-operations. For example, the processor may determine sub-operation B as one target operation, and then take sub-operation B, sub-operation C, and sub-operation D as target sub-operations. During the execution of sub-operation B, sub-operation C, and sub-operation D, the processor may obtain the position information related to the first object and control the display state of the second object.

For example, when the user wants to interact with the first object, the user may focus on the first object and raise the hand to move near the first object. The plurality of sub-operations performed in sequence in this interaction operation may include: focusing on the first object, raising the hand, and moving the hand from the initial position to the vicinity of the first object. Raising the hand may be an action before moving the hand, and it may be considered that this action will not affect the display state of the second object. The sub-operation of focusing the user's sight on the first object may realize the movement of the user's sight from other positions to the first object, and generate the position information related to the first object. Therefore, this sub-operation may be used as a target sub-operation to obtain the position information related to the first object in the operation. The sub-operation of moving the hand from the initial position to the vicinity of the first object may change the position of the user's hand and the first object, and generate the position information related to the first object. Therefore, this sub-operation may be used as a target sub-operation to obtain the position information related to the first object in the operation.

According to the embodiments of the present disclosure, multiple continuous actions of the user may be decomposed, and only effective operations may be selected and corresponding position information may be obtained, such that the display state of the second object may be controlled more accurately, and the position information generated by the invalid operation of the user which frequently affects the display state of the second object and brings a bad interactive experience may be avoided.

In some embodiments of the present disclosure, in response to the operation parameter satisfying the target condition, displaying the second object may include: in response to the operation parameter satisfying the target condition, generating a virtual light source, where the position of the virtual light source relative to the first object is consistent with the position of an operation object performing the interactive operation relative to the first object; and displaying the second object formed by the virtual light source irradiating the first object.

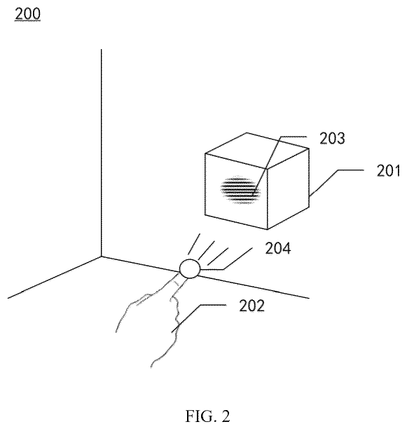

FIG. 2, which is a schematic diagram showing an application scenario of the display method according to the embodiments of the present disclosure, is used as an example to describe the process of displaying the second object based on the virtual light source.

As shown in FIG. 2, in the 3D scene 200, the cube 201 is the first object that the user wants to interact with. The texture part 203 is the second object. The texture part 203 is obtained by irradiating the virtual light source 204 on the cube 201. The virtual light source may be set on the user's hand 202, and the emission position of the virtual light source 204 always remains relatively unchanged with the position of the user's hand 202. For example, the position of the virtual light source 204 may be the same as the position of the user's hand 202, or the virtual light source 204 may be set at a predetermined position directly in front of or directly above the user's hand 202. In an embodiment of the present disclosure, the virtual light source may be set to be invisible to the user, such that the user avoids unnecessary interference factors and observes the texture part 203 generated by the virtual light source.

In one embodiment of the present disclosure, the operation object for performing the interactive operation may be an object such as a user's hand or an operation handle that is manipulated and used to interact with the first object.

For example, the operation parameter satisfying the target condition may include that the distance between the operation object and the first object is within a preset threshold. At this time, the virtual light source set on the user's hand 202 may be incident on the cube 201 along the direction of the user's finger. Since the virtual light source is a light source with a texture, the image with a specific texture formed by the light emitted by the virtual light source irradiating on the first object may be the second object. The image of the second object is formed based on the texture image of the virtual light source.

The position of the virtual light source may be consistent with the position of the operation object. When the position of the operation object changes, the position of the virtual light source may also change accordingly, and the display state of the second object may also change.

In one embodiment of the present disclosure, when the operation object is moved, the textured virtual light source may move accordingly because of the movement of the operation object, and the specific texture image irradiated on the first object may also change accordingly. When the user finds it difficult to perceive the exact position of the first object, the change of the texture image of the second object may help the user better perceive the first object, thereby optimizing the interaction experience with the first object.

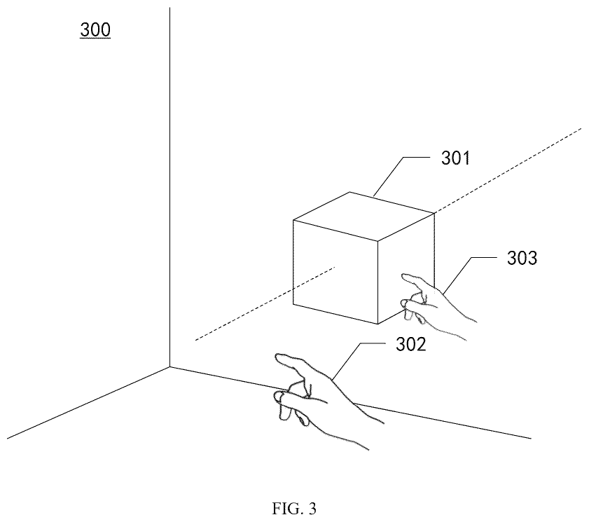

FIG. 3 is a schematic diagram showing an application scenario of a display method according to another embodiment of the present disclosure.

As shown in FIG. 3, in a 3D scene 300, a cube 301 is the first object that the user wants to interact with. A virtual hand 303 is a second object obtained by mapping the user's real hand 302 in the 3D scene. The posture and position of the displayed virtual hand in the 3D scene may correspond to the real hand one by one. For example, when the user makes a fist, the virtual hand in the 3D scene may also follow the user's real hand to complete the same fist-making action; or, when the user moves his hand upward, the virtual hand in the 3D scene may also move upward accordingly.

For example, in the 3D scene 300, the size of the second object's virtual hand may follow the rule that it is larger when it is near and smaller when it is far away, and the clarity of the virtual hand may change according to the law that the display state is clearer when it is closer to the first object. By changing the display state of the second object in accordance with the cognitive laws of real life, it may help users understand and complete interactive operations on the first object more easily.

In some embodiments of the present disclosure, in response to the operation parameter satisfying the target condition, displaying the second object may include: in response to the operation parameter satisfying the target condition, obtaining sight line information of the operation object performing the interactive operation; and displaying the second object at a target position indicated by the sight line information.

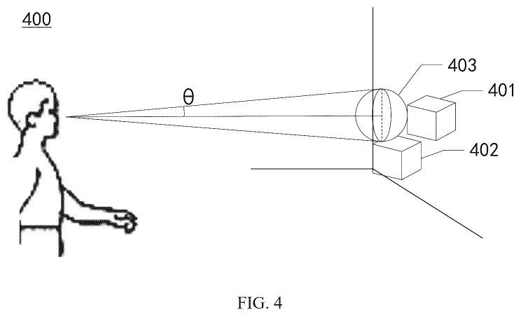

FIG. 4, which is a schematic diagram showing an application scenario of a display method according to another embodiment of the present disclosure, will be used as an example to illustrate the process of displaying the second object based on the user's sight line.

As shown in FIG. 4, the user may achieve scene interaction in the 3D scene through hand-eye collaboration.

In one embodiment of the present disclosure, the operation parameter satisfying the target condition may include that the user chooses to use the sight line to control the cursor movement, and the second object, that is, the cursor area 403, is displayed in the direction indicated by the user's sight line in the 3D scene 400. The user may select the first object from multiple objects (such as cube 401 and cube 402) in the 3D scene by moving the cursor area 403. A target position is determined in the direction of the user's sight line, and a cursor area is generated according to the target position. The cursor area 401 may be a circular cursor generated with the target position as the center of the circle, or a spherical or hemispherical cursor generated with the target position as the center of the sphere.

The cursor area 401 may be the second object formed by the user's sight line projected in the 3D scene 400, and the display form may be an indicating cursor. The sight line angle θ may be used to characterize the display state of the cursor area 401, such as the size or shape of the cursor.

When the user's sight line moves in the scene, the cursor area 401 may move accordingly based on the user's sight line, and the size of the cursor area 401 may change according to the moving speed of the user's sight line.

In some embodiments of the present disclosure, the size of the cursor area 401 may be represented by the sight line angle θ. When the sight line angle θ is larger, the cursor area 401 may be larger; and, when the sight line angle θ is smaller, the cursor area 401 also may become smaller. The maximum threshold angle θ1 and the minimum threshold angle θ2 of the sight line angle may be preset such that the cursor area 401 changes its size based on the moving speed of the sight line within a predetermined range of variation.

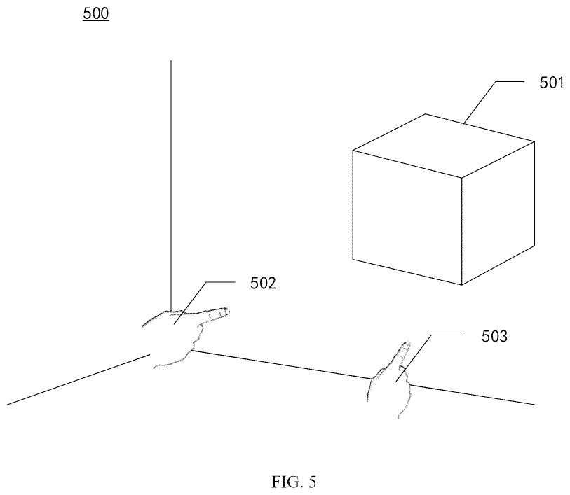

FIG. 5 is a schematic diagram showing controlling the display state according to an embodiment of the present disclosure.

As shown in FIG. 5, in a 3D scene 500, an operation object 502 or an operation object 503 performs an interactive operation on a cube 501, and the position of the operation object 502 may be used as the first position or the second position. And correspondingly, the position of the operation object 503 may be used as the second position or the first position. When the operation object moves from the first position to the second position, the second object may gradually or immediately transition from the first display state to the second display state.

In one embodiment of the present disclosure, the position information may include a first position and a second position of the operation object that performs an interactive operation, and the display state may include a first display state and a second display state. Based on the position information, controlling the display state of the second object may include: in response to the operation object moving from the first position to the second position, controlling the second object to switch from the first display state to the second display state.

According to one embodiment of the present disclosure, the interactive operation may be the operation object moving from the first position to the second position, and the position information may represent the process of the operation object moving from the first position to the second position. In the process of moving from the first position to the second position, the position of the operation object relative to the first object may change. The first display state may be a display state corresponding to the second object when the operation object is in the first position. The second display state may be a display state corresponding to the second object when the operation object is in the second position.

For example, the interactive operation shown in FIG. 5 is that the user moves the operation object from the first position to the second position. The position of the operation hand 502 may be the first position, and the position of the operation hand 503 may be the second position. Compared with the first position, the distance between the second position and the cube 501 is closer.

In one embodiment, the second object may be the texture pattern shown in FIG. 2. When the user performs the interactive operation shown in FIG. 5, the area and clarity of the texture image generated by the virtual light source projected on the surface of the cube 501 may change accordingly.

For example, when the operation object moves from the first position to the second position closer to the cube 501, the area of the texture image generated by the virtual light source projected on the surface of the cube 501 may decrease accordingly, and the projected texture may become clearer. The first display state of the second object may be a state in which the area of the texture image is large and the texture is fuzzy, and the second display state may be a state in which the area of the texture image is small and the texture is clearer.

In another embodiment, the second object may be the virtual hand shown in FIG. 3. When the user performs the interactive operation shown in FIG. 5, the size and clarity of the virtual hand may change accordingly.

For example, when the operation object moves from the first position to the second position closer to the cube 501, the size of the virtual hand may gradually decrease because of the law that it is larger when it is near and smaller when it is far away, and the clarity of the virtual hand may gradually increase as it gets closer to the first object. The first display state of the second object may be that the size of the virtual hand is larger and the definition is lower, and the second display state of the second object may be that the size of the virtual hand is smaller and the definition is higher.

In another embodiment, the second object may be the cursor area shown in FIG. 4. When the user performs the interactive operation shown in FIG. 5, the size of the cursor area may change accordingly. For example, when the operation object moves from the first position to the second position closer to the cube 501, the moving speed of the sight line of the user may increase from 0 and then return to 0, such that the cursor area changes its size based on the change in the moving speed of the sight line of the user.

For example, when the sight line of the user is at the position corresponding to the operation object 502, the cursor area may be an area with the sight line angle less than 10 degrees. When the sight line of the user moves from the position corresponding to the operation object 502 to the position corresponding to the operation object 503, the cursor area may be an area with a sight line angle less than 7 degrees. When the sight line of the user stays at the position corresponding to the operation object 503, the cursor area may slowly increase from the area with a sight line angle less than 7 degrees to the area with a sight line angle less than 10 degrees. When the sight line angle changes, the size of the cursor area may also change accordingly.

In one embodiment of the present disclosure, the position information may include a first positional relationship between the first object and the operation object performing the interactive operation. Based on the position information, controlling the display state of the second object may include: based on the first positional relationship, controlling the display state of the second object.

In some embodiments of the present disclosure, the first positional relationship may be a positional relationship between the user's hand or the user's sight and the first object. When the relative position between the operation object and the first object 501 changes, the first positional relationship may change, and the display state of the second object may also change accordingly.

For example, the operation object may be the user's hand, and the second object may be a texture image generated by a virtual light source projected on the cube 501. Correspondingly, the first positional relationship may be the positional relationship between the user's hand and the cube 501. When the first positional relationship changes, the display state of the texture image may change accordingly.

Based on the first positional relationship, the change in the relative distance between the operation object and the first object during the interactive operation may be determined. For example, based on the first positional relationship, it may be determined that the operation object is gradually approaching the first object. Therefore, the area of the texture image generated by controlling the virtual light source to be projected on the surface of the first object 501 may become smaller, and the projected texture may be clearer. As another example, based on the first positional relationship, it may be determined that the operation object is gradually moving away from the first object. Therefore, the area of the texture image generated by controlling the virtual light source to be projected on the surface of the first object 501 may increase accordingly, and the projected texture may gradually become blurred.

As another example, the operation object may be the user's hand, and the second object may be a virtual hand formed by the operation object projected in the 3D scene 500. Therefore, the first positional relationship may be the positional relationship between the user's hand and the cube 501. When the first positional relationship changes, the position and size of the virtual hand may change accordingly.

For example, based on the first positional relationship, it may be determined that the operation object is gradually approaching the first object. Therefore, the virtual hand may also gradually approach the first object, and the size may gradually decrease. When it is determined based on the first positional relationship that the operation object is gradually moving away from the first object, the virtual hand may move away from the first object and the size may gradually increase.

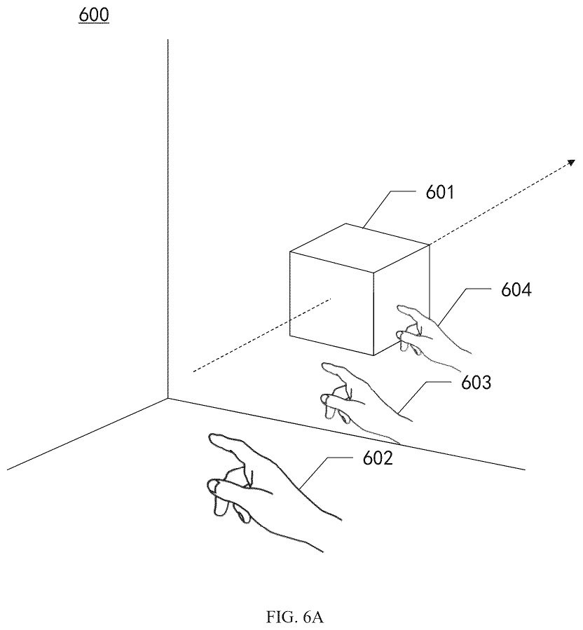

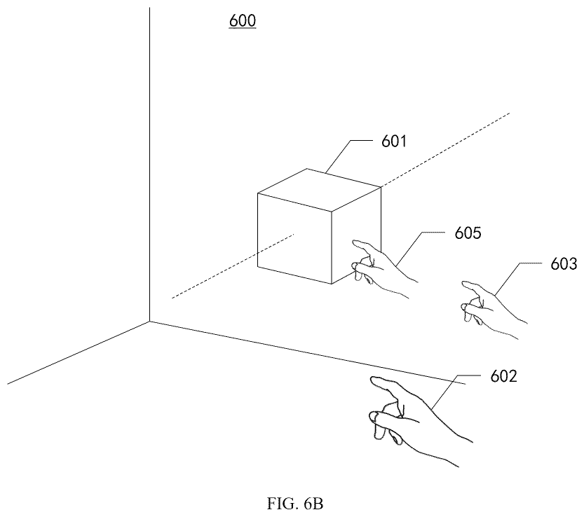

FIG. 6A is another schematic diagram showing controlling the display state according to another embodiment of the present disclosure.

As shown in FIG. 6A, in the 3D scene 600, the cube 601 may be the first object, the user's hand 602 may be the operation object, and the virtual hands 603 and 604 may be second objects in different display states respectively.

According to an embodiment of the present disclosure, the position information may include a first positional relationship between a first object and an operation object that performs an interactive operation. Based on the position information, controlling the display state of a second object may include: determining a second positional relationship according to the first positional relationship, where the second positional relationship is a positional relationship between the first object and the second object; and controlling the display state of the second object according to the second positional relationship.

In some embodiments of the present disclosure, when the second object is a virtual hand formed by the operation object projected in a 3D scene, the first positional relationship may be the positional relationship between the user hand 602 and the cube 601, and the second positional relationship may be the positional relationship between the virtual hand 603 or the virtual hand 604 and the cube 601.

When the first positional relationship between the user hand 602 and the cube 601 changes, the second positional relationship between the virtual hand and the cube 601 may also change accordingly, and the display state of the virtual hand may change accordingly.

For example, based on the first positional relationship, it may be determined that the user hand 602 is gradually approaching the cube 601, and based on the second positional relationship, it may be determined that the second object is also moved from the virtual hand 603 to the virtual hand 604. Therefore, because the virtual hand is getting closer and closer to the cube 601, the clarity of the virtual hand may gradually increase.

For example, based on the first positional relationship, it may be determined that the user hand 602 is gradually moving away from the cube 601, and based on the second positional relationship, it may be determined that the second object is also moving from the position of the virtual hand 604 along the dotted line pointing direction to a position farther from the cube 601. Therefore, because the virtual hand is getting farther and farther from the cube 601, the clarity of the virtual hand may gradually decrease.

In some embodiments of the present disclosure, the display state of the second object may be jointly controlled based on the first positional relationship and the second positional relationship.

For example, based on the first positional relationship, it may be determined that the user hand 602 is gradually approaching the cube 601, and based on the second positional relationship, it may be determined that the second object is moved from the virtual hand 603 to the position of the virtual hand 604. Therefore, based on the change of the first positional relationship, the size of the virtual hand may gradually decrease based on the law that it is larger when closer and smaller when far away, and the clarity of the virtual hand may gradually increase.

For example, based on the first positional relationship, it may be determined that the user's hand 602 gradually moves away from the cube 601, and based on the second positional relationship, it may be determined that the second object moves from the position of the virtual hand 604 along the dotted line pointing direction to a position farther from the cube 601. Therefore, based on the change of the first positional relationship, the size of the virtual hand may gradually decrease based on the law that it is larger when closer and smaller when far away, and based on the change of the second positional relationship, the clarity of the virtual hand may gradually decrease.

According to an embodiment of the present disclosure, based on the position information, controlling the display state of the second object may include: determining a first rate according to the second positional relationship between the first object and the second object, where the position information includes the first positional relationship between the operation object performing the interactive operation and the first object and the second positional relationship is determined based on the first positional relationship; and controlling the second object to change the display state at the first rate. Since the display state of the second object may be a change in size, the first rate may be the size change rate of the second object.

In some embodiments of the present disclosure, the second positional relationship may be determined based on the first positional relationship, while the moving distance of the operation object represented by the first positional relationship may not be directly equal to the moving distance of the second object represented by the second positional relationship. When the operation object is close to the first object, the operation object may move a smaller distance, which may correspond to the same moving distance of the second object. When the operation object is far away from the first object, the operation object may move a smaller distance, which may correspond to a larger moving distance of the second object.

For example, the distance between the second object and the first object may be close. The interactive operation may indicate that the user interacts with the first object that is close. In the process of the operation object moving toward the first object, the size of the second object may change at a smaller first rate, and the corresponding moving speed of the second object may be slower. For example, the operation object may move 3 cm, and the corresponding second object may generate a moving distance of 5 cm. When the movement distance of the second object is short, the moving speed of the second object during the execution of the interactive operation may be also slow, such that the change of the display state of the second object may be also correspondingly slow.

For example, the distance between the second object and the first object may be far. The interactive operation may indicate that the user interacts with the first object that is far away. In the process of the operation object moving in the direction close to the first object, the size of the second object may change at a larger first rate, and the corresponding moving speed of the second object may be faster. For example, the operation object moves 3 cm, and the corresponding second object generates a movement distance of 50 cm. When the movement distance moved of the second object is larger, the moving speed of the second object during the execution of the interactive operation may be also faster, such that the change of the display state of the second object may be also faster accordingly.

According to the embodiments of the present disclosure, the display state of the second object may be determined by the first positional relationship and the second positional relationship, and the display state may change in size based on different rates. The reference of the above multiple parameters may enable the change of virtual objects in the 3D scene to restore the physical laws of the real world and conform to the user's cognition. For example, when the distance between the second object and the first object is far, the user may only need to control the second object to move a longer distance in the virtual world through a shorter distance movement in the real world (control the second object to move at a faster moving speed in a fixed time), which reduces the user's interaction burden. Further, by controlling the moving speed of the second object and the change rate of the display state, the fine operation of the virtual hand may be shown to the user at a slower rate.

In one embodiment of the present disclosure, the display method may further include: determining the interaction intention indicated by the interaction operation; and, based on the interaction intention and the second object, displaying a third object with a target display state, where the position information includes the positional relationship between the operation objects performing the interaction operation, and when the positional relationship satisfies a target positional relationship, the display state of the second object is set to a target display state.

FIG. 6B, which is a schematic diagram showing controlling the display state according to another embodiment of the present disclosure, will be used as an example to illustrate the process of displaying the third object based on the interaction intention.

According to one embodiment of the present disclosure, the interaction intention may represent a specific action that the user wants to achieve on the first object through the interaction operation. For example, the interaction intention may include that the user wants to touch the first object, pick up the first object, throw the first object, or push the first object. The target display state may be a display state corresponding to the second object when the interaction intention is realized. The third object may be a reference object with the target display state, which is used to be presented to the user and guide the user to change the position information, such that the display state of the second object is the same as the display state of the third object, realizing the user's interaction intention.

As shown in FIG. 6B, the cube 601 is the first object, the virtual hand 603 is the second object mapped by the user's real hand 602 in the 3D scene 600, and the hand image 605 is the third object determined based on the interaction intention. The hand image 605 is the third object, and the hand display state represented by the third object is the target display state.

In one embodiment, the second object may be a texture image generated by the virtual light source projected on the cube 601. When the interaction intention of touching the first object is to be realized, the target display state displayed by the third object may be a pattern with a fixed size and clear texture. Therefore, under the influence of the first positional relationship, the display state of the second object may be different from the size and clarity of the target display state. The user may move the operation object and observe the change of the display state of the second object at the same time to make it consistent with the third object, thereby realizing the interaction operation of touching the first object.

For example, the second object may be a virtual hand formed by the operation object projected in the 3D scene. When the interaction intention of pushing the first object is to be realized, the target display state displayed by the third object may be that the fingers of the virtual hand are spread out, the palm faces the first object, and at this time the virtual hand may have the corresponding size and clarity. Under the influence of the first positional relationship, the display state of the second object may be different from the target display state in size and clarity. The user may change the posture and position of the operation object and observe the change of the display state of the second object to make it consistent with the third object, thereby realizing the interactive operation of promoting the first object.

In another example, the second object may be a cursor area generated in a 3D scene based on the user's sight line. When the interactive intention of clicking the first object is to be realized, the target display state displayed by the third object may be a cursor area focused on the center position of the first object. Under the influence of the first positional relationship, the cursor area may be located at other positions in the scene. The user may realize the interactive operation of clicking the first object by moving the sight line until the cursor area coincides with the third object.

According to the embodiments of the present disclosure, after determining the user's interactive intention, the user may be given appropriate prompts through the third object as a reference object, thereby helping the user to quickly perceive and complete the interactive operation with the first object, improving the interaction efficiency and optimizing the user experience.

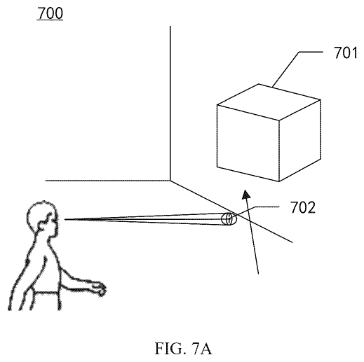

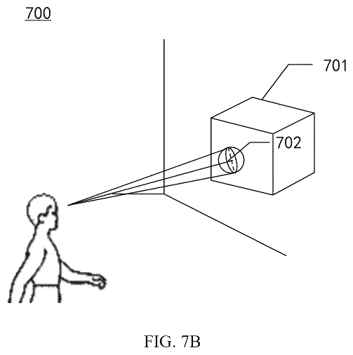

FIG. 7A and FIG. 7B are schematic diagrams showing controlling the display state according to another embodiment of the present disclosure.

According to another embodiment of the present disclosure, based on the position information, controlling the display state of the second object may include: determining a second rate based on the position information, where the second rate is the rate at which the positional relationship between the operation object performing the interactive operation and the first object changes during the execution of the interactive operation; and controlling the display state of the second object according to the second rate.

As shown in FIG. 7A, in a 3D scene 700, the operation object for performing the interactive operation is the user's sight line, the first object is a cube 701, and the second object is a cursor area 702 projected in the 3D scene. When the position information indicates that the user moves the sight line from other places to the first object at the second rate, the cursor area 702 corresponding to the user's sight line moves accordingly in the direction of the arrow, and the sight line angle forming the cursor area 702 changes according to the second rate. When the second rate at which the user's sight line moves is faster, the sight line angle is smaller, and the size of the cursor area is smaller.

As shown in FIG. 7B, the position information indicates that the user's sight line is focused on the first object, and the cursor area 702 covers the cube 701. Therefore, the user's sight line remains stationary, the second rate is 0, and the size of the generated cursor area gradually recovers to the size before the movement.

In some embodiments of the present disclosure, after the user's sight line is focused on the first object, during the process of restoring the size of the cursor area, the user may directly perform the interactive operation through a predetermined gesture, or may maintain the predetermined gesture while moving the cursor area to select the first object from multiple objects in the scene.

According to the embodiments of the present disclosure, by dynamically adjusting the cursor area displayed by the sight line in the 3D scene, the accuracy of hand-eye collaboration in selecting the target and the accuracy of the sight line tracking algorithm may be improved. By determining the size of the cursor area based on the rate of change of the user's sight line information, the cursor area may be improved to follow the user's sight line. Further, when the sight line changes quickly, the cursor area moves in a smaller size, which may also reduce the interference of the cursor area on the user's sight line.

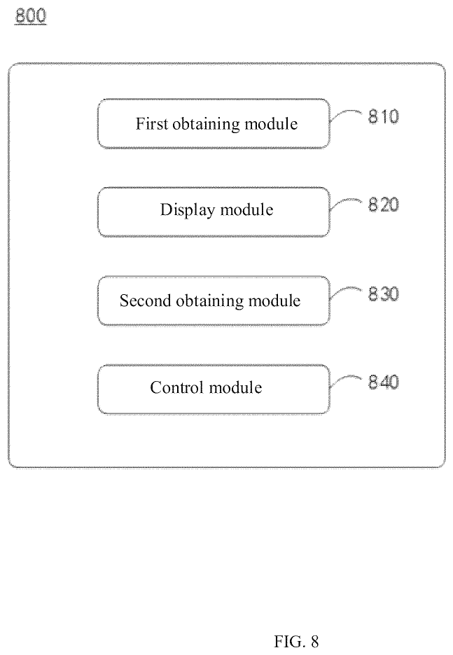

The present disclosure also provides a display device. FIG. 8 is a schematic structural diagram of a display device according to an embodiment of the present disclosure.

As shown in FIG. 8, in one embodiment, the display device 800 may include a first obtaining module 810, a display module 820, a second obtaining module 830, and a control module 840.

The first obtaining module 810 may be configured to obtain an interactive operation and an operation parameter for a first object, where the operation parameter characterizes the interactive operation, and the first object is displayed in a naked eye 3D state. In one embodiment, the first obtaining module 810 may be used to perform S110 described above, which will not be repeated here.

The display module 820 may be configured to display a second object in response to the operation parameter satisfying a target condition. In one embodiment, the display module 820 may be used to perform S120 described above, which will not be repeated here.

The second obtaining module 830 may be configured to obtain position information related to the first object in response to the interactive operation. In one embodiment, the second obtaining module 830 may be used to perform S130 described above, which will not be repeated here.

The control module 840 may be configured to control a display state of the second object based on the position information. In one embodiment, the control module 840 may be used to perform S140 described above, which will not be repeated here.

The second obtaining module may include a first determination submodule and an acquisition submodule.

The first determination submodule may be configured to determine multiple sub-operations that are performed in sequence included in the interactive operation.

The acquisition submodule may be configured to obtain the position information related to the first object in response to target sub-operations in the multiple sub-operations.

In one embodiment of the present disclosure, the position information may include the first position and the second position of the operation object performing the interactive operation, and the display state may include the first display state and the second display state. The control module may include a first control submodule, which is configured to control the second object to switch from the first display state to the second display state in response to the operation object moving from the first position to the second position.

In one embodiment of the present disclosure, the position information may include a first positional relationship between the first object and the operation object performing the interactive operation. The control module may include a second control submodule, which is configured to control the display state of the second object based on the first positional relationship.

In one embodiment of the present disclosure, the position information may include a first positional relationship between the first object and the operation object performing the interactive operation. The control module may include a second determination submodule and a third control submodule.

The second determination submodule may be configured to determine a second positional relationship based on the first positional relationship, where the second positional relationship is a positional relationship between the first object and the second object.

The third control submodule may be configured to control the display state of the second object based on the second positional relationship.

In one embodiment of the present disclosure, the control module may include a third determination submodule and a fourth control submodule.

The third determination submodule may be configured to determine a first rate based on a second positional relationship between the first object and the second object, where the position information includes a first positional relationship between the operation object performing the interactive operation and the first object, and the second positional relationship is determined based on the first positional relationship.

The fourth control submodule may be configured to control the second object to change its display state at a first rate.

In one embodiment of the present disclosure, the control module may include a fourth determination submodule and a fifth control submodule.

The fourth determination submodule may be configured to determine a second rate based on the position information, where the second rate is a rate at which the positional relationship between the operation object performing the interactive operation and the first object changes during the execution of the interactive operation.

The fifth control submodule may be configured to control the display state of the second object based on the second rate.

In one embodiment of the present disclosure, the display module may include a first generation submodule and a first display submodule.

The first generation submodule may be configured to generate a virtual light source in response to the operation parameter satisfying the target condition, where the position of the virtual light source relative to the first object is consistent with the position of the operation object performing the interactive operation relative to the first object.

The first display submodule may be configured to display the second object formed by the virtual light source irradiating the first object.

In one embodiment of the present disclosure, the display module may include a second generation submodule and a second display submodule.

The second generation submodule may be configured to obtain the sight line information of the operation object performing the interactive operation in response to the operation parameter satisfying the target condition.

The second display submodule may be configured to display the second object at the target position indicated by the sight line information.

In one embodiment of the present disclosure, the display device 800 may further include a determination module and a third object display module.

The determination module may be configured to determine the interactive intent indicated by the interactive operation.

The third object display module may be configured to display a third object with a target display state based on the interactive intent and the second object, where the position information includes the positional relationship between operation objects performing the interactive operation, and when the positional relationship satisfies the target positional relationship, the display state of the second object is set to the target display state.

It should be noted that the collection, storage, use, processing, transmission, provision, disclosure and application of user personal information involved in the technical solution of this disclosure are in compliance with the provisions of relevant laws and regulations, necessary confidentiality measures have been taken, and they do not violate public order and good morals. In the technical solution of this disclosure, the user's authorization or consent is obtained before obtaining or collecting user personal information.

The present disclosure also provides an electronic apparatus, a readable storage medium, and a computer program product.

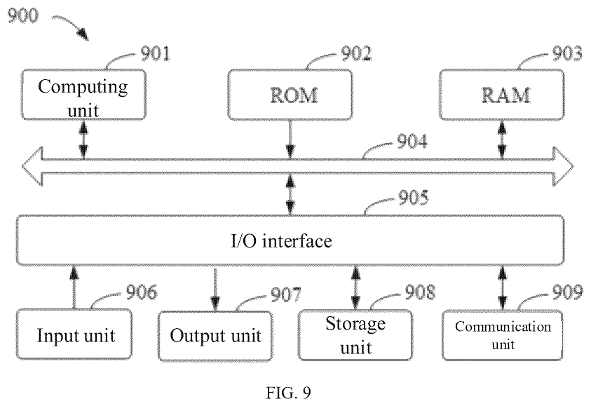

FIG. 9 is a schematic structural diagram of an example electronic apparatus 900 that may be used to implement any method provided by various embodiments of the present disclosure. The electronic apparatus can be any suitable form of digital computers, such as laptop computers, desktop computers, workstations, personal digital assistants, servers, blade servers, mainframe computers, or other suitable computers. The electronic apparatus may also be any suitable form of mobile devices, such as personal digital processing, cellular phones, smart phones, wearable devices, or other similar computing devices. The components shown herein, their connections and relationships, and their functions are merely examples and are not intended to limit the implementation of the present disclosure described and/or required herein.

As shown in FIG. 9, the electronic apparatus 900 includes a computing unit 901, which is configured to perform various appropriate actions and processes according to a computer program stored in a read-only memory (ROM) 902 or a computer program loaded from a storage unit 908 into a random access memory (RAM) 903. In RAM 903, various programs and data required for the operation of the device 900 may also be stored. The computing unit 901, ROM 902, and RAM 903 are connected to each other via a bus 904. An input/output (I/O) interface 905 is also connected to the bus 904.

Multiple components in the electronic apparatus 900 are connected to the I/O interface 905, including: an input unit 906, such as a keyboard, a mouse, etc.; an output unit 907, such as various types of displays, speakers, etc.; a storage unit 908, such as a disk, an optical disk, etc.; and a communication unit 909, such as a network card, a modem, a wireless communication transceiver, etc. The communication unit 909 allows the electronic apparatus 900 to exchange information/data with other apparatuses through a computer network such as the Internet and/or various telecommunication networks.

The computing unit 901 may be various general and/or special processing components with processing and computing capabilities. Some examples of the computing unit 901 include, but are not limited to, a central processing unit (CPU), a graphics processing unit (GPU), various special artificial intelligence (AI) computing chips, various computing units running machine learning model algorithms, a digital signal processor (DSP), or any appropriate processor, controller, microcontroller, etc. The computing unit 901 may perform the various methods and processes described above, such as the display method. For example, in some embodiments, the display method may be implemented as a computer software program, which is tangibly contained in a machine-readable medium, such as the storage unit 908. In some embodiments, part or all of the computer program may be loaded and/or installed on the electronic apparatus 900 via the ROM 902 and/or the communication unit 909. When the computer program is loaded into the RAM 903 and executed by the computing unit 901, one or more operations of the display method described above may be performed. Alternatively, in other embodiments, the computing unit 901 may be configured to perform the display method in any other appropriate manner (e.g., by means of firmware).

Various embodiments of the systems and techniques described above herein may be implemented in digital electronic circuit systems, integrated circuit systems, field programmable gate arrays (FPGAs), application specific integrated circuits (ASICs), application specific standard products (ASSPs), systems on chips (SOCs), complex programmable logic devices (CPLDs), computer hardware, firmware, software, and/or any combinations thereof. These various embodiments may include: being implemented in one or more computer programs that can be executed and/or interpreted on a programmable system including at least one programmable processor, which can be a special-purpose or general-purpose programmable processor that can receive data and instructions from a storage system, at least one input device, and at least one output device, and transmit data and instructions to the storage system, the at least one input device, and the at least one output device.

The program code for implementing the method of the present disclosure can be written in any combination of one or more programming languages. These program codes can be provided to a processor or controller of a general-purpose computer, a special-purpose computer, or other programmable data processing device so that the program code, when executed by the processor or controller, causes the functions/operations specified in the flowchart and/or block diagram to be implemented. The program code can be executed entirely on the machine, partially on the machine, partially on the machine as a stand-alone software package and partially on a remote machine, or entirely on a remote machine or server.

In the context of the present disclosure, a machine-readable medium may be a tangible medium that can contain or store a program for use by or in conjunction with an instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media may include electrical connections based on one or more wires, a portable computer disk, a hard disk, a random access memory (RAM), a read-only memory (ROM), an erasable programmable read-only memory (EPROM or flash memory), optical fibers, a portable compact disk read-only memory (CD-ROM), an optical storage device, a magnetic storage device, or any suitable combination of the foregoing.

To provide interaction with a user, the systems and techniques described herein may be implemented on a computer including: a display device (e.g., a CRT (cathode ray tube) or LCD (liquid crystal display) monitor) for displaying information to the user; and a keyboard and pointing device (e.g., a mouse or trackball) through which a user can provide input to the computer. Other types of devices may also be used to provide interaction with a user; for example, feedback provided to a user may be any form of sensory feedback (e.g., visual feedback, auditory feedback, or tactile feedback); and input from a user may be received in any form (including acoustic input, voice input, or tactile input).

The systems and techniques described herein may be implemented in a computing system including a backend component (e.g., as a data server), or a computing system including a middleware component (e.g., an application server), or a computing system including a frontend component (e.g., a user computer with a graphical user interface or a web browser through which a user can interact with an implementation of the systems and techniques described herein), or a computing system including any combination of such backend components, middleware components, or frontend components. The components of the system may be interconnected by any form or medium of digital data communication (e.g., a communication network). Examples of communication networks include: a local area network (LAN), a wide area network (WAN), or the Internet.

A computer system may include a client and a server. The client and server are generally remote from each other and typically interact through a communication network. The client and server relationship is created by computer programs running on respective computers and having a client-server relationship to each other. The server can be a cloud server, also known as a cloud computing server or cloud host, which is a host product in the cloud computing service system to solve the defects of difficult management and weak business scalability in traditional physical hosts and VPS servers (Virtual Private Server, or VPS for short). The server can also be a server of a distributed system, or a server combined with a blockchain.

It should be understood that the various forms of processes shown above can be used to reorder, add or delete operations. For example, the operations in this disclosure can be executed in parallel, sequentially, or in different orders, as long as the desired results of the technical solution disclosed in this disclosure can be achieved, and this document does not limit it here.

The above is only an implementation method of the present disclosure, but the protection scope of the present disclosure is not limited thereto. Those skilled at the art may easily think of changes or replacements within the technical scope disclosed in the present disclosure, which should be covered within the protection scope of the present disclosure.

What is claimed is:

1. A display method comprising:
obtaining an interactive operation and an operation parameter for a first object displayed in a naked-eye 3D state, the operation parameter characterizing the interactive operation;
displaying, in response to the operation parameter satisfying a target condition, a second object;
obtaining, in response to the interactive operation, position information related to the first object; and
controlling a display state of the second object based on the position information.

2. The method according to claim 1, wherein obtaining, in response to the interactive operation, the position information includes:
determining a plurality of sub-operations included in the interactive operation and executed in sequence; and
obtaining the position information related to the first object in response to a target sub-operation among the plurality of sub-operations.

3. The method according to claim 1, wherein:
the position information includes a first position and a second position of an operation object performing the interactive operation;
the display state includes a first display state and a second display state; and
controlling the display state of the second object based on the position information includes:
in response to the operation object moving from the first position to the second position, controlling the second object to switch from the first display state to the second display state.

4. The method according to claim 1, wherein:
the position information includes a positional relationship between the first object and an operation object that performs the interactive operation; and
controlling the display state of the second object based on the position information includes:
controlling the display state of the second object based on the positional relationship.

5. The method according to claim 1, wherein:
the position information includes a first positional relationship between the first object and an operation object that performs the interactive operation; and
controlling the display status of the second object based on the position information includes:
determining, based on the first positional relationship, a second positional relationship between the first object and the second object; and
controlling the display status of the second object based on the second positional relationship.

6. The method according to claim 1, wherein:
the position information includes a first positional relationship between the first object and an operation object that performs the interactive operation; and
controlling the display state of the second object based on the position information includes:
determining a rate according to a second positional relationship between the first object and the second object, the second positional relationship being determined based on the first positional relationship; and
controlling the second object to change the display state at the first rate.

7. The method according to claim 1, wherein controlling the display state of the second object based on the position information includes:
determining, based on the position information, a rate at which a positional relationship between an operation object performing the interactive operation and the first object changes during the interactive operation; and
controlling the display state of the second object according to the rate.

8. The method according to claim 1, wherein displaying the second object includes:
generating a virtual light source, a position of the virtual light source relative to the first object being consistent with a position of an operation object performing the interactive operation relative to the first object; and
displaying the second object formed by the virtual light source irradiating the first object.

9. The method according to claim 1, wherein displaying the second object includes:
obtaining sight line information of an operation object performing the interactive operation; and
displaying the second object at a target position indicated by the sight line information.

10. An electronic apparatus, comprising:
a memory storing a computer program; and
a processor configured to execute the computer program to:
obtain an interactive operation and an operation parameter for a first object displayed in a naked-eye 3D state, the operation parameter characterizing the interactive operation;
display, in response to the operation parameter satisfying a target condition, a second object;
obtain, in response to the interactive operation, position information related to the first object; and
control a display state of a second object based on the position information.

11. The electronic apparatus according to claim 10, wherein the processor is further configured to execute the computer program to, when obtaining, in response to the interactive operation, the position information:
determine a plurality of sub-operations included in the interactive operation and executed in sequence; and
obtain the position information related to the first object in response to a target sub-operation among the plurality of sub-operations.

12. The electronic apparatus according to claim 10, wherein:
the position information includes a first position and a second position of an operation object performing the interactive operation;
the display state includes a first display state and a second display state; and
the processor is further configured to execute the computer program to, when controlling the display state of the second object based on the position information:
in response to the operation object moving from the first position to the second position, control the second object to switch from the first display state to the second display state.

13. The electronic apparatus according to claim 10, wherein:
the position information includes a positional relationship between the first object and an operation object that performs the interactive operation; and
the processor is further configured to execute the computer program to, when controlling the display state of the second object based on the position information:
control the display state of the second object based on the positional relationship.

14. The electronic apparatus according to claim 10, wherein:
the position information includes a first positional relationship between the first object and an operation object that performs the interactive operation; and
the processor is further configured to execute the computer program to, when controlling the display status of the second object based on the position information:
determine, based on the first positional relationship, a second positional relationship between the first object and the second object; and
control the display status of the second object based on the second positional relationship.

15. The electronic apparatus according to claim 10, wherein:
the position information includes a first positional relationship between the first object and an operation object that performs the interactive operation; and
the processor is further configured to execute the computer program to, when controlling the display state of the second object based on the position information:
determine a rate according to a second positional relationship between the first object and the second object, the second positional relationship being determined based on the first positional relationship; and
control the second object to change the display state at the rate.

16. The electronic apparatus according to claim 10, wherein the processor is further configured to execute the computer program to, when controlling the display state of the second object based on the position information:
determine, based on the position information, a rate at which a positional relationship between an operation object performing the interactive operation and the first object changes during the interactive operation; and
control the display state of the second object according to the rate.

17. The electronic apparatus according to claim 10, wherein the processor is further configured to execute the computer program to, when displaying the second object:
generate a virtual light source, a position of the virtual light source relative to the first object being consistent with a position of an operation object performing the interactive operation relative to the first object; and
display the second object formed by the virtual light source irradiating the first object.

18. The electronic apparatus according to claim 10, wherein the processor is further configured to execute the computer program to, when displaying the second object:
obtain sight line information of an operation object performing the interactive operation; and
display the second object at a target position indicated by the sight line information.

19. A non-transitory computer-readable storage medium storing a computer program that, when executed by a processor, causes an electronic apparatus having the processor to:
obtain an interactive operation and an operation parameter for a first object displayed in a naked-eye 3D state, the operation parameter characterizing the interactive operation;
display, in response to the operation parameter satisfying a target condition, a second object;
obtain, in response to the interactive operation, position information related to the first object; and
control a display state of a second object based on the position information.

20. The storage medium according to claim 19, wherein the computer program, when executed by the processor, further causes the electronic apparatus to, when obtaining, in response to the interactive operation, the position information:
determine a plurality of sub-operations included in the interactive operation and executed in sequence; and
obtain the position information related to the first object in response to a target sub-operation among the plurality of sub-operations.
